(19) United States
(12) Patent Application Publication
(10) Pub. No.: US 2022/0411175 A1
(43) Pub. Date: Dec. 29, 2022

(54) Self-Loading Panel System

(71) Applicants: Jan CHABOT, Pointe-Claire (CA); LOCAL NET HOLDINGS, INC., Reading, PA (US)

(72) Inventor: Jan Chabot, Pointe-Claire (CA)

(21) Appl. No.: 17/299,404

(22) PCT Filed: Nov. 3, 2020
(86) PCT No.: PCT/US2020/058758

§ 371 Date: Jun. 3, 2021

(51) Int. Cl. B65D 88/54; B65D 19/42

(52) U.S. Cl. CPC B65D 88/546; B65D 19/42; B65D 2519/00781; B65D 2519/00273

(57) ABSTRACT

A self-loading pallet system is disclosed where a three-dimensional basic structure can be manipulated horizontally and vertically and carry with it a cargo, loaded either directly into the structure, or onto a separate pallet structure inserted into the basic structure. The system is useful for loading and unloading cargo between ground level and the cargo floor of vehicles. The vertical loading steps are accomplished by a sequence of extensions and retractions of legs slidably attached to the basic structure. The vertical leg movements are powered by actuators that extend and retract their pistons attached to telescoping legs of the basic structure. Each actuator has an interior motor and a dedicated controller operating the motor. An exterior master controller communicates with each actuator controller, whereby the sequence of vertical loading steps can be pre-programmed to effectively automate the loading and unloading sequences. Actuator motors are powered by an exterior rechargeable battery.

### TECHNICAL FIELD

The present pallet system relates broadly to customizable pallets and other loadable platforms. It also relates to mobile shipping containers and industrial housing units with mechanisms for self-loading them onto transporting means and unloading them from same, without manual lifting or the use of external lifting equipment. Most such means and surfaces are not roofed, i.e. flatbed trucks and railway flatcars.

More specifically, it relates to containers and container like products adapted to be self-loaded by one individual into and unloaded out of roofed vehicles such as closed body trucks, capped pickups, cargo and minivans and SUVs. Self=loadable container like products may in turn be customized for a range of varied uses and their operation be partly automated.

It excludes exterior devices for loading and unloading that are not incorporated in the loadable objects, such as cranes, fork and platform lifts, tow motors, ramp devices, etc. Excluded as well are loading devices mounted in or on transporting means or on fixed surfaces to retrieve, or help retrieve, loadable objects from ground or other levels.

### PRIOR ART

Prior art for self-loadable objects was described and critiqued in a prior PCT application PCT/US2019/029340 titled self-loading container filed Apr. 26, 2019 by this inventor. The prior PCT application was published on Oct. 31, 2019 with publication #WO/2019/21016. This current PCT application titled Self-Loading Panel System has a priority date of Nov. 4, 2019, when PPA No. 62/929,952 was filed with the USPTO. As such, a prior art grace period is believed to apply to this current PCT application. Prior art examples for this application are listed in an Information Disclosure Statement or IDS separately filed herewith.

In one end of the spectrum, industrial shipping containers and mobile housing units with hydraulic lifting means dominate prior art. In the other end is found a lesser segment of prior art with smaller sized self-loading products, like shopping carts, ambulatory stretchers and the like, using mechanical or manual self loading means. A few other self-loading products and patents have recently appeared in the field. Otherwise, prior art has primarily produced self-loading products for very specific uses that are able to afford it. Most are complicated and costly to manufacture and would not be mechanically nor economically suitable to render more common objects self-loading.

### DISCLOSURE OF INVENTION

There is one segment of the self-loading industry segment that has barely been addressed by prior art. Namely, the need for inexpensive ways to make intermediate sized objects, like regular and oversized custom pallets, containers and container like products, self-loadable into the rears of roofed vehicles like closed body trucks, cargo and mini vans, SUVs and the like. Particularly so, for objects that are too heavy, numerous or dangerous for individuals to load and unload manually. Commercially, that includes mobile shipping platforms, stands and containers as well as shop furniture and equipment for the trades, machine shops, retail, display, exhibition, catering and last mile delivery. Industrially, that includes self-loading storage, office, living units, shipping containers and even mobile buildings. For the consumer market, that includes self-loading mobile products customized for sports teams, flea and farmers markets, travel, camping, hunting, fishing, picnics and other recreational activities. These needs have been growing along with the increasing self-reliance and entrepreneurial spirit of society in general, together with increasing e-commerce and commercially prepared and delivered meals that require ever more specialized delivery capabilities.

What is proposed and claimed is a self-loading structure, or SLS, that can be customized in terms of size, shape and function to be used in the above mentioned product categories with a range of embodiments and further ramifications. The mechanical improvements over prior art as well as the programmed automation proposed and claimed will make the self-loading of cargo more effortless, safer and simpler to use by lesser skilled operators.

One particular use of the described SLS is the customizing of it to accept insertion of a self-loading pallet, or SLP, with cargo that can then be loaded and unloaded as part of an SLS and SLP combo. The SLS and the inserted SLP with its cargo can be customized as to width, length and height to fit into almost any size cargo area, including delivery vans with extra long wheelbases and extra high roofs. As such, one individual can safely perform the loading and unloading of heavy or multiple items shipped together.

The drawings and detailed description thereof teach an economical way to customize, machine, assemble and operate an SLS with or without an SLP. The SLS without the SLP can further be vertically customized into self-loadable containers with top or side openings, machine and retail shop shelving, cabinets and tables, catering stations with hot and cold compartments, as well as many consumer and recreational self-loading products. Vehicle floor sized pallets can be horizontally customized for a range of commercial uses and inserted into an SLS for automated loading and delivery of items or materials.

### BRIEF DESCRIPTION OF THE DRAWINGS

For a fuller understanding of the proposed self-loading pallet system and examples of alternative embodiments thereof, provided below is a list of reference numerals and a detailed description of the accompanying drawings wherein SLS refers to a self-loading structure and SLP refers to a self-loading pallet and where:

FIGS. 1A through 6G are the same drawings as were originally filed with PPA No. 62/929,952 on Nov. 4, 2019. They form the basis for the claims herewith, also as filed with the same PPA. For these drawings, short versions of the SLS and SLP were used, thus enabling the largest scale of drawings for maximum clarity of illustration.

FIGS. 7A through 10F are new drawings added with this PCT application. They are examples of various SLS customizations, intended to illustrate actual industrial uses to support the industrial applicability section of the specification. For these drawings, longer versions of the SLS and of various customized pallets were used. The SLS height and widths used here are customized to the maximum dimensions that can fit into a 2019 Mercedes Sprinter Van with a 170-inch wheelbase and a high roof profile.

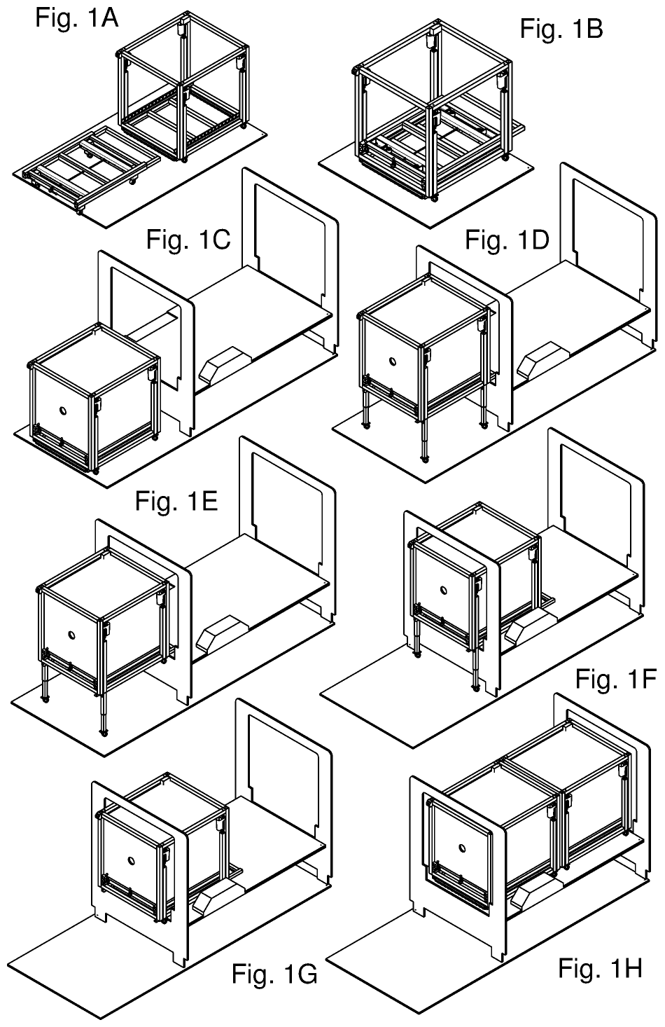

FIGS. 1A through 1H are perspective side views, showing the steps of loading an SLP inserted into and carried by an SLS from ground level to the cargo floor of a van.

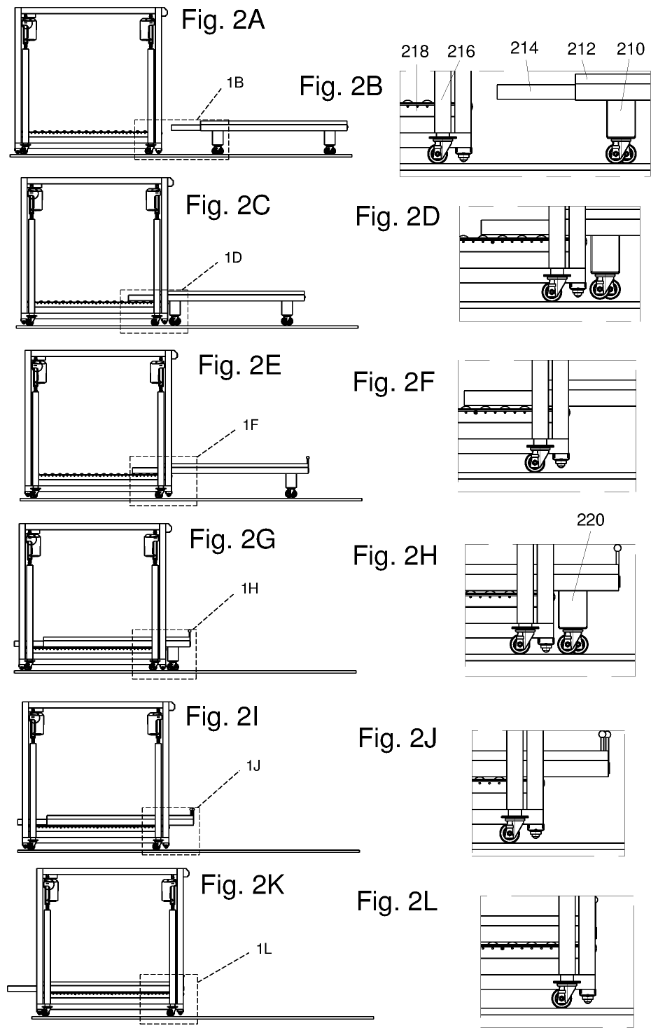

FIGS. 2A through 2L are orthogonal side views, showing the steps and details of loading or inserting an SLP into and to be carried by an SLS with both on ground level.

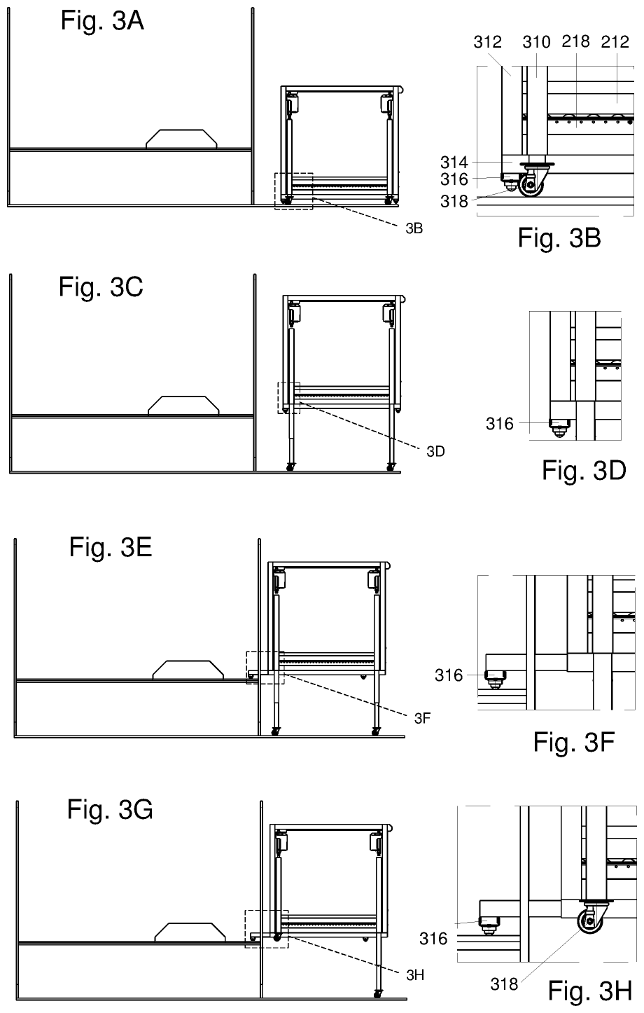

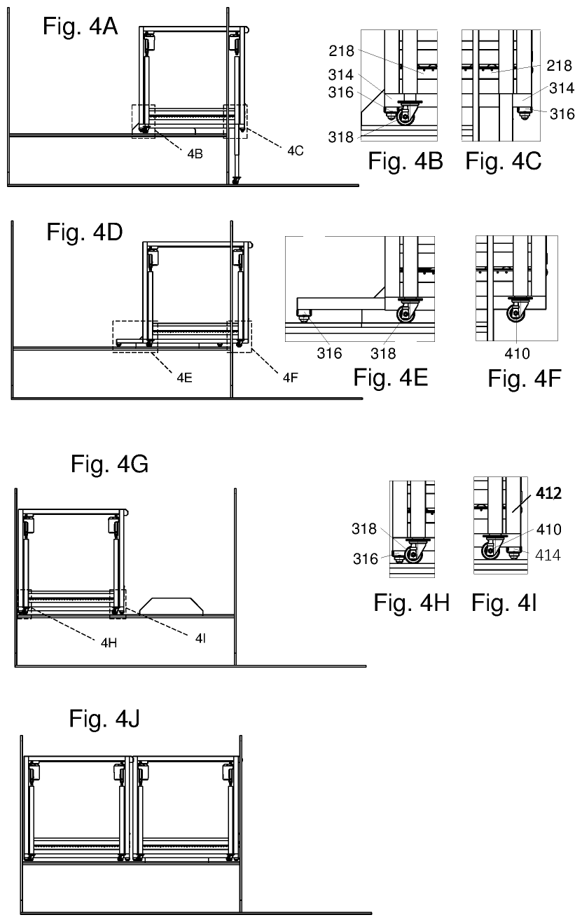

FIGS. 3A through 4J are orthogonal side views, showing the steps and details of loading an SLS into a van.

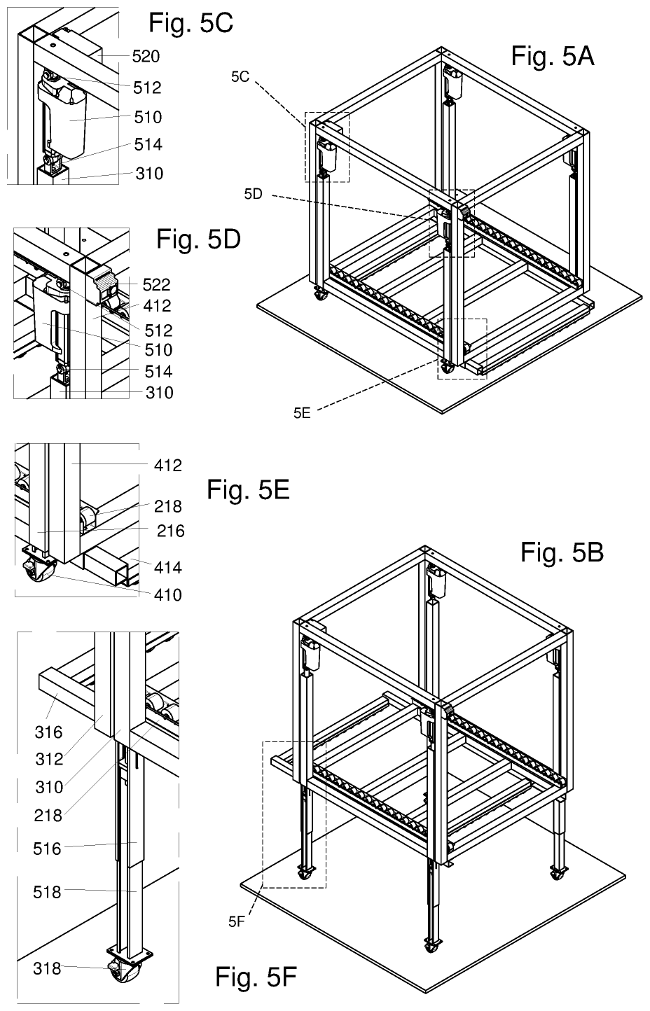

FIGS. 5A through 5F are perspective views of an SLS, showing the parts and functions that allow its elevation and lowering needed for self-loading.

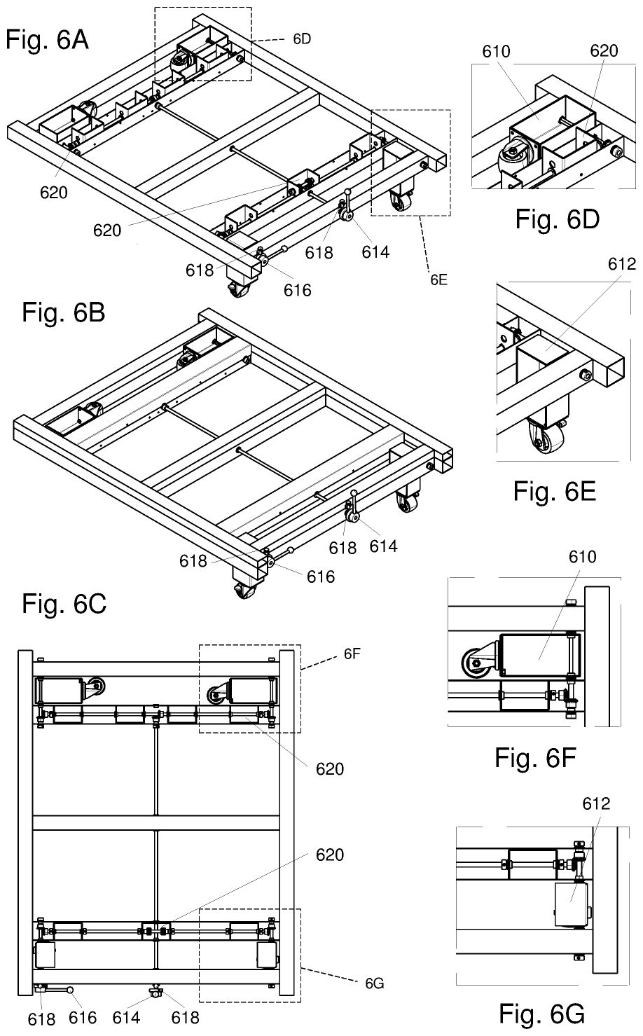

FIGS. 6A through 6F are perspective and orthogonal views of an SLP, and its parts and functions that extend and retract its casters for its insertion into an SLS.

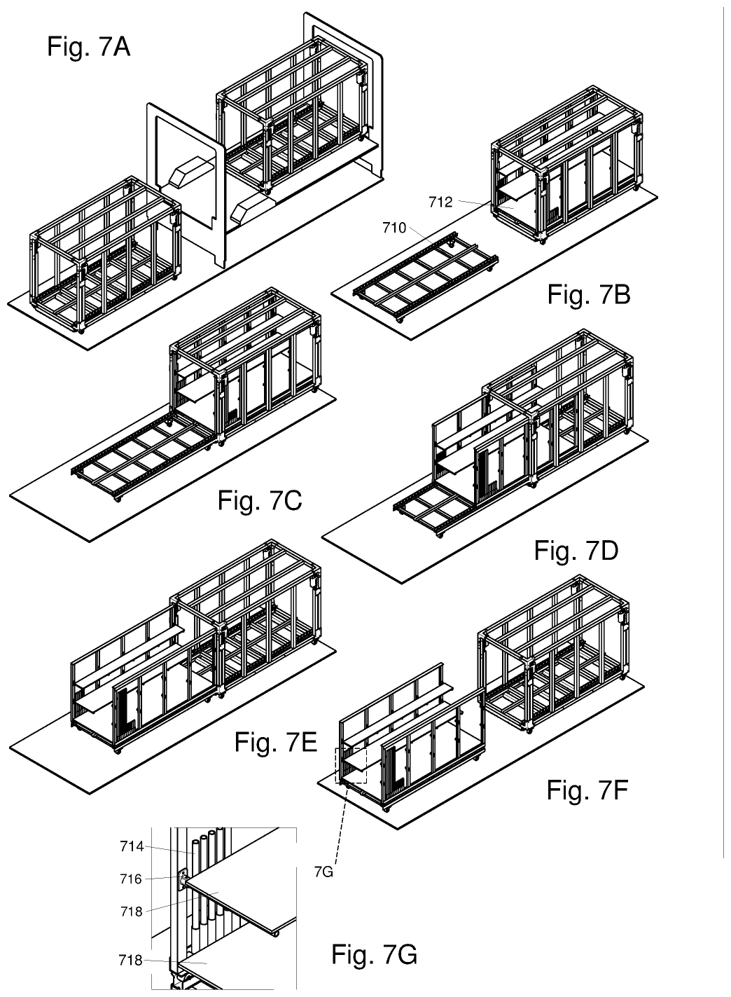

FIGS. 7A through 7G are perspective views of an SLS in a Sprinter Van and of an SLS pallet system customization for loading & delivery of building materials in bulk.

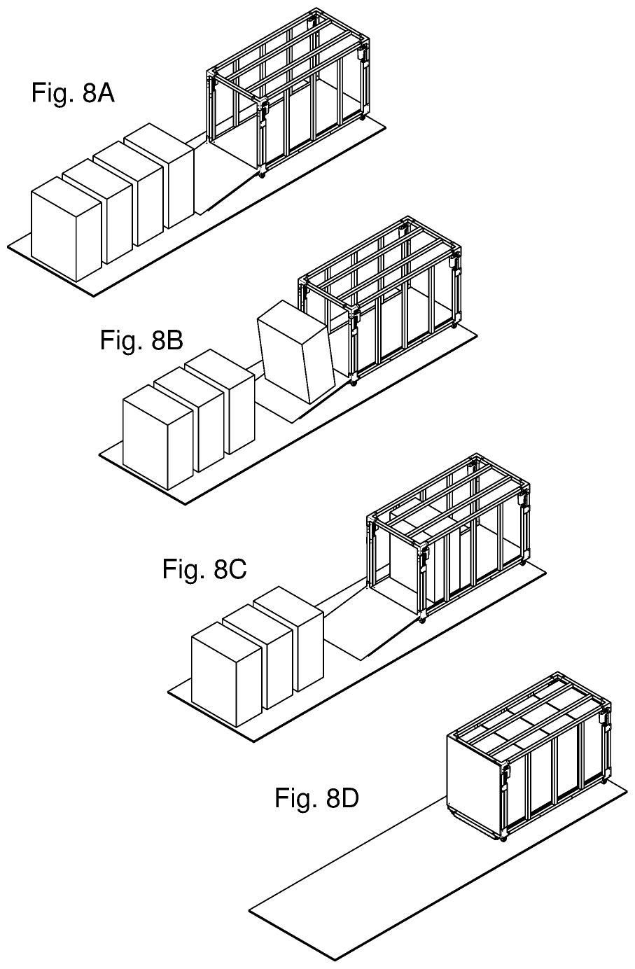

FIGS. 8A through 8D are perspective views of non-palletized wheeled cargo items loaded into bottom floor of SLS without wheel flow rail support.

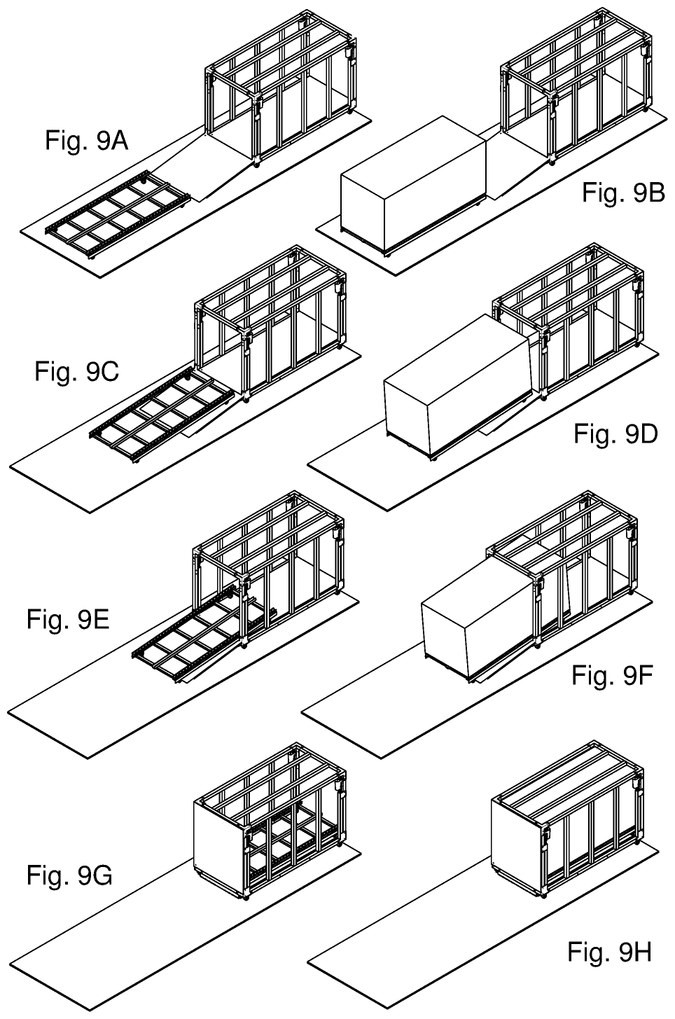

FIGS. 9A through 9H are perspective views of a pallet on non-retractable casters, with a large cargo item, loaded into bottom floor of SLS without wheel flow rail support.

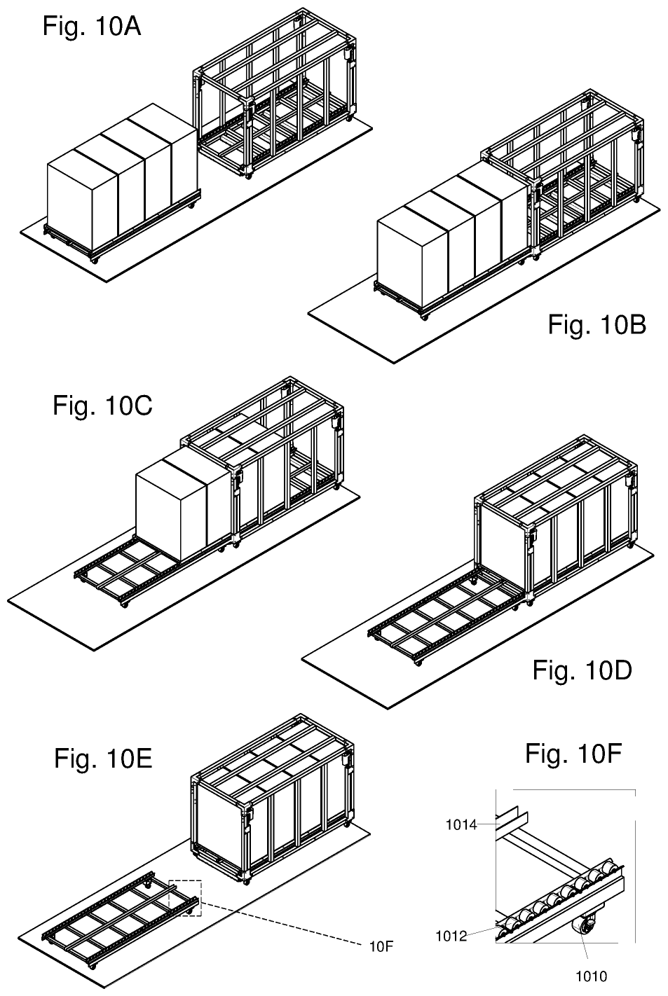

FIGS. 10A through 10F are perspective views of a pallet on casters delivering non-wheeled cargo items into an SLS without itself entering and loading with the SLS.

### LIST OF REFERENCE NUMERALS FOR PARTS SHOWN IN DRAWINGS

For expediency, the first digit in a reference numeral, up to 9, and first two digits after that, identify the drawing sheet #where a referred part is first introduced:
210 SLP Rear Caster Support
212 SLP Horizontal Frame
214 SLP Horizontal Frame Extension
216 SLS Retractable Leg Assembly
218 SLS Wheel Flow Rail for SLP Support
220 SLP Front Caster Support
310 SLS Retractable Leg Housing
312 SLS Vertical Rear Frame
314 SLS Horizontal Bottom Frame
316 SLS Extendable Support Frame
318 SLS Rear Caster
410 SLS Front Caster
412 SLS Vertical Front Frame
414 SLS Ball Transfer Flow Rail
510 SLS Actuator Housing
512 SLS Upper Clevis Rod End
514 SLS Lower Clevis Rod End
516 SLS Telescoping Leg Part—Upper
518 SLS Telescoping Leg Part—Lower
520 SLS Rechargeable Li-Ion Battery
522 SLS Master Controller
610 SLP Caster Support—Retracted
612 SLP Caster Support—Extended
614 SLP Rear Casters Toggle Handle
616 SLP Front Casters Toggle Handle
618 SLP Toggle Handle Lock
620 SLF Shaft Support
710 EFP Exterior Floor Pallet
712 SLTP Self-loading Transfer Pallet
714 SLTP Tubular Support
716 SLTP Holed Fixture
718 SLTP Shelving
1010 Pallet Caster
1012 Pallet Cargo Support Flow Rail
1014 Pallet Cargo Support Guide Rail

### MODES FOR CARRYING OUT THE INVENTION

### Description—Sequential Steps in Self-Loading—FIGS. 1A Through 1H

The self-loading pallet system has two main components. The self-loading pallet, or SLP, can with or without cargo be inserted into and carried by the self-loadable structure, or SLS. The SLS must be vertically manipulated to accommodate insertion of the SLP. The SLS, with or without an inserted SLP, can be vertically and horizontally manipulated from a starting level to a receiving level. When the SLS is loaded into a van or other vehicle, the typical starting level is ground, and the receiving level is the vehicle cargo floor. When the SLS is unloaded from a van or other vehicle, the typical starting level is vehicle cargo floor, and the receiving level is the ground.

Both the SLS and the SLP have caster wheels and as such can each be independently manipulated on any horizontal level such as on building or vehicle floors. When the SLP is inserted into and carried by the SLS, they can be manipulated in unison, both horizontally and vertically.

The SLS is loaded into and out of the rear of a vehicle. The rear of the SLS is first to enter vehicle. The front of the SLS is last to enter vehicle. Similarly, the rear of the SLP enters the SLS first and its front last. The front of the SLS carries the master controller digitally manipulating its leg extensions and retractions. Alternatively, the controller may be operated wirelessly unconnected to the SLS. Loading and unloading is simplified by a series of pre-programmed steps extending and retracting the pistons of actuators that are connected to the extendable and retractable SLS legs. Details of loading both the SLP and SLS by leg manipulation are shown in subsequent FIGS. 2A through 4J.

FIGS. 1A through 1H are perspective side views, showing the steps of loading an SLP inserted into and carried by an SLS from ground level to the cargo floor of a van.

FIG. 1A shows an SLP, without cargo to better illustrate this step, ready to insert into an SLS, here both shown on ground level. FIG. 1B shows the SLP now fully inserted and carried by the SLS. The detailed operation and manipulation steps of inserting the SLP into the SLS are shown in subsequent FIGS. 2A through 2L.

FIG. 1C shows an SLP with cargo, fully inserted into an SLS that is in turn positioned on ground level behind the rear opening of a van, also on ground level. The van is a simplified representation of its cargo area showing only those perimeters that are essential to the loading of the SLS with or without the SLP from ground level to the van cargo floor. Specifically, the essential dimensions are: (a) Van cargo floor height above ground level, (b) Height and width of van rear doors opening, (c) Width between van wheel wells, if less than width of rear opening, and (d) Length of usable van cargo floor, not at floor level as specified by the manufacturer, but between rear top of van front seats and inside of van rear doors.

The van dimensions illustrated here are those of a 2019 Ford Transit Van with a 147.6-inch wheelbase and a medium height roof. The height and width of the SLS shown here are customized to the maximum dimensions that can be loaded into this size van. The length of the SLS shown here is customized to allow exactly two of them to fit into the cargo area of this size van. Depending on actual cargo sizes to be loaded by user, the length of the SLS and SLP can be customized up to 124 inches, which is the total length of the cargo area of this size van. Similar customizations of the SLS and SLP dimensions can be made to fit into other size vans, trucks or other vehicles.

FIG. 1D shows the SLS, carrying its SLP, vertically elevated to a level where the bottom of the SLS is above the cargo floor of the van. FIG. 1E shows the SLS with its rear legs retracted. This is possible because its rear end is now supported on the cargo floor of the van by an extendable frame slidingly attached to the bottom of the SLS. It is shown here horizontally extended onto van cargo floor. FIG. 1F shows the SLS horizontally advanced and supported on van cargo floor to the point where its front legs are now positioned on ground level right behind the rear opening of the van. FIG. 1G shows the front legs of the SLS now also fully retracted, which allows the SLS to be further advanced onto the van cargo floor. FIG. 1H shows a second same size SLS similarly loaded onto and advanced on van cargo floor. The detailed operation and manipulation steps of loading the SLS into the van are shown in subsequent FIGS. 3A through 4J.

### Operation—Sequential Steps in Self-Loading—FIGS. 2A Through 4I

FIGS. 2A through 2L are orthogonal side views, showing the steps and details of loading or inserting an SLP into and to be carried by an SLS with both on ground level.

The SLP rolls on two rear casters operated in unison and two front casters operated in unison. The SLP enters the SLS with its rear casters first. The SLP casters are attached to caster supports that can either be extended to position casters on ground or retracted from contact with the ground. The caster supports are retracted by revolving them 90 degrees, whereby they align with the horizontal frame of the SLP. Extension and retraction of the casters can only take place when they are off the ground.

After the SLP is advanced and inserted into the SLS, the SLP horizontal frame with an adjustable frame extension rests and rolls on wheel flow rails in the bottom of the SLS frame. SLP insertion into the SLS involves steps of slightly extending and retracting the four legs of the SLS, each extending from four leg assemblies. These steps allow first the two rear SLP casters, on their caster supports, and next the two front SLS casters, on their caster supports, to be retracted. These steps in reverse are also needed when retracting or separating the SLP from the SLS.

FIG. 2A like FIG. 1A shows an SLP, without cargo to better illustrate this step, ready to insert into an SLS, here both shown on ground level. FIG. 2B is a detail showing the alignment of the SLP with the SLS before insertion. The two SLP rear caster supports 210 are extended whereby their casters in turn support the SLP on ground level. SLP horizontal frame 212 has a customizable horizontal frame extension 214. Before the SLP is advanced towards the SLS for insertion, the SLS legs in retractable leg assemblies 216 are slightly retracted to position SLS wheel flow rails for SLP support 218 at a level slightly below the level of SLP frame extension 214.

FIG. 2C shows the SLP frame extension now inserted into the SLS. FIG. 2D is a detail showing that the SLS legs have now been slightly extended to lift the SLS to a point where the SLS flow rails now support the SLP frame extension and where the SLP rear casters are now off the ground to allow their retraction. FIG. 2E and detailed FIG. 2F show the SLP rear casters now retracted by revolving into alignment with the SLP frame. The mechanical details of the revolving retraction are illustrated further on subsequent FIGS. 6A through 6G.

FIG. 2G and detailed FIG. 2H show the SLP advanced most of the way into the SLS. The SLS legs are here again slightly retracted to a point where the SLP front casters on supports 220 are on ground. The SLP frame, supported by the SLS flow rails, has been advanced into the SLS to a point where SLP front caster supports 220 abut the SLS front end. FIG. 2I and detailed FIG. 2J show the SLS legs again slightly extended which allowed the retraction of the SLP front caster supports. FIG. 2K and detailed FIG. 2L show the SLP fully advanced and inserted into the SLS, supported by the SLS flow rails and with all four SLP casters retracted. As shown in subsequent FIGS. 5A through 5F, all SLS vertical leg movements are powered and controlled by pre-programmed actuators.

FIGS. 3A through 4J are orthogonal side views, showing the steps and details of loading an SLS into a van.

FIG. 3A, like FIG. 10, shows an SLP with cargo, fully inserted into an SLS that is positioned on ground level behind the rear opening of a van, also on ground level. Detailed FIG. 3B shows SLS rear retractable leg in housing 310 supported on ground. SLS vertical rear frame 312 is connected to SLS horizontal bottom frame 314, which in turn supports slidingly extendable and lockable SLS support frame 316. Support frame 316 is an essential component in the self-loading process and claims as subsequently shown. It carries a series of ball transfer flow rails perpendicular to SLS frame 314. At least two flow rails are needed, located under the rear and front ends of frame 316. The ball transfers allow frame 316 to provide temporary rolling means for support of the SLS when its legs are fully retracted. The two SLS flow rails 218, on the other hand, run parallel with SLS frame 314. They carry a series of wheels that support SLP horizontal frame 212 as the SLP is slidingly inserted into the SLS.

FIG. 3C, like FIG. 1D, shows the SLS, carrying its SLP, vertically elevated to a level where the bottom of the SLS is above the cargo floor of the van. Detailed FIG. 3D shows the SLS legs extended to a point where the SLS extendable support frame 316 is aligned slightly above the cargo floor.

FIG. 3E and detailed FIG. 3F show frame 316 extended with its flow rails now resting on van cargo floor after a slight retraction of the SLS legs.

FIG. 3G, like FIG. 1E, and detailed FIG. 3H show the SLS with its rear leg casters 318 fully retracted to be slightly above the flow rails of frame 316. FIG. 3H further shows the rear of the SLS now totally supported by frame 316 with its flow rails resting on van cargo floor.

FIG. 4A, like FIG. 1F, shows the SLS horizontally advanced and supported on van cargo floor to the point where the SLS front legs are now positioned on ground right behind the rear opening of the van. Detailed FIGS. 4B and 4C show flow rails 218 supporting the SLP inside the SLS. They further show SLS horizontal bottom frame 314 supporting both rear and front ends of frame 316. Finally, they show SLS rear caster 318 supporting the SLS rear end on the van cargo floor. The front end of the SLS is still supported by its front leg casters on ground as shown in FIG. 4A. The SLS is here elevated by a slight extension of its legs, so frame 316 is again slidable, and as such may optionally remain extended or be retracted to be under the SLS.

FIG. 4D, like FIG. 1G, shows the front legs of the SLS now fully retracted, which will allow the SLS to be further advanced onto the van cargo floor. Detailed FIGS. 4E and 4F show rear end of frame 316 advanced on van cargo floor, whereby its front end is also advanced enough to support the front end of the SLS on the van cargo floor. This in turn allows casters 410 on the SLS front legs to be retracted to the same level of rear casters 318 and that of the flow rails of frame 316.

FIG. 4G, like FIG. 1G, shows the SLS fully advanced on the van cargo floor. Detailed FIGS. 4H and 4I show both SLS rear casters 318 and front casters 410 supported on van cargo floor. The SLS legs had temporarily been extended slightly to allow the retraction of frame 316. Shown here is its rear end 316 and its front end, from where one of the perpendicular ball transfer flow rails 414 project, later also shown in bird's-eye view in FIG. 5E. Frame 316 can optionally remain horizontally mobile, or can be made to support SLS on van cargo floor by slightly retracting or extending the supporting SLS legs. Also shown here is SLS vertical front frame 412.

FIG. 4J, like FIG. 1H, shows a second SLS similarly loaded onto and advanced on van cargo floor. Again, the sequence of all the above SLS leg extensions and extractions has been fully automated by pre-programming of the master controller directing each of the four actuators. Their pistons control the two front leg movements in unison and the two rear leg movements in unison. These front and rear leg movements are needed to load any given SLS into and out of any given vehicle design. They can also be used to tilt an SLS forwards or backwards on any surface like ground

Alternatively, by controlling the two left legs in unison and the two right legs in unison, the SLS can be tilted sideways. Lowering or raising the SLS or tilting it can be used for unloading bulk cargo, or for positioning the SLS for convenient loading or unloading.

### Description—Self-Loading Structure and Pallet—FIGS. 5A through 6G

FIGS. 5A through 5F are perspective views of an SLS, showing the parts and functions that allow its programmed elevation and lowering needed for self-loading.

FIG. 5A shows the SLS with its legs retracted. FIG. 5B shows it with its legs extended. FIG. 5C details the rear left top corner of the SLS. An actuator in its housing 510 is attached to the SLS top frame by upper clevis rod end 512 and to its retractable leg in housing 310 by lower clevis rod end 514. Actuator housing 510 encloses a programmable controller and a 12 volt dc electrical motor connected by interior gearing to telescoping tubing, the last stage of which is a piston that extends or retracts a telescoping leg ending in a caster.

Actuator LA36 by manufacturer Linak fulfills the load and stroke capacity required for this SLS. The actuator can send and receive data with the SAE j1939 protocol based on Controller Area Network (CAN). It is well known to CAN-bus system designers and manufactures of electric automotive systems.

A rechargeable Li-Ion battery 520 is here also attached to the top left rear corner of the SLS. Recharged from the vehicle electrical system when the SLS is traveling in the vehicle, battery 520 can be located anywhere on the SLS, convenient for charging, but without interfering with its cargo. Electric wiring is carried inside the SLS tubular structure, so is not shown here. It connects to the battery that provides power to the motors and controllers in each actuator, and optionally to the master controller. There is an array of manufacturers and makes of suitable Li-Ion batteries that continually improve on their capacity.

FIG. 5D details the front left top corner of the SLS. The parts and functions are similar to the parts and functions discussed under FIG. 5C. The exception is master controller 522, here attached to the top of SLS front frame 412. Controller 522 communicates with the four individual actuator controllers that in turn direct piston motion to each of the four extendable SLS legs. Controller 522 can optionally be disconnected from the SLS frame, have its own battery and communicate wirelessly, handheld or otherwise. Multinational manufacturer Danfoss has several wired and wireless controllers that have proven to work well with actuator LA36.

FIG. 5E details the left front bottom corner of the SLS frame where the leg is shown as retracted. Vertical front frame 412 supports retractable leg assembly 216 and indirectly the SLS extendable support frame where ball transfer flow rails 414 are perpendicularly attached to both its ends at minimum. The number of flow rails and ball transfer units in each flow rail is determined by the total weight of the SLS, the SLP and its cargo to be carried. SLS leg assembly 216 comprises the retractable leg and its caster 410.

FIG. 5F details the parts enclosed in the SLS rear left retractable leg housing 310. The leg is here shown in one of its extended positions and its side is opened for a clearer view. The leg has an upper telescoping part 516 and a lower telescoping part 518. It carries caster 318 on its bottom. FIG. 5F also shows SLS vertical rear frame 312 indirectly supporting SLS extendable support frame 316, here shown partly extended.

FIGS. 6A through 6F are perspective and orthogonal views of an SLP, and its parts and functions that extend and retract its casters for its insertion into an SLS.

FIG. 6A is a perspective view of the bottom section of the SLP frame. The rear SLP frame and casters face forward and enter the SLS first. FIG. 6A exposes the shafts and gearing that connect the rear casters to toggle handle 614 and those that connect the front casters to toggle handle 616. Those handles in their upright position retract their respective caster supports with their casters. In their level position they extend their respective caster supports with their casters. Toggle handle locks 618 are spring plungers inserted into and retracted out of holes in clamping shaft collars. They secure either position of this 90-degree toggle. Shaft supports 620, with flanged bearing inserts, support shafts in various locations along their extensions inside the lower section of the SLP frame.

FIG. 6B is a perspective of the finished SLP after its top section is combined with its bottom section. Again handles 614 and 616 are shown as well as handle locks 618. FIG. 6C shows the orthogonal version of FIG. 6A from its top.

FIG. 6D details in perspective the retracted caster support 610 with its caster. FIG. 6E details in perspective the extended caster support 612 with its caster. FIGS. 6F and 6G are the corresponding orthogonal versions of FIGS. 6D and 6E, respectively.

Extension and retraction of the caster supports is accomplished by rotating toggle handles 614 and 616 by 90 degrees. When retracted, the caster supports with their casters are simply rotated to align and be flush with the horizontal SLP frame. In order to insert the SLP into the SLS it is necessary to retract the rear casters and the front casters independently from each other. Insertion was already demonstrated on page 2/10 of the drawings.

### Customization Demos—Self-Loading Structures—FIGS. 7A Through 10F

FIGS. 7A through 7G are perspective views of an SLS in a Sprinter Van and of an SLS pallet system customization for loading & delivery of building materials in bulk.

FIG. 7A shows a 103 inch long SLS on ground and a similar size SLS loaded fully forward into a Sprinter Van with a 170-inch wheelbase and a high roof profile. Approximately 55 inches of free cargo space remains in rear of van, either for a longer SLS or for cargo loaded by other means. Here both SLS are shown empty. If cargo is loaded directly into the SLS, before it is self-loaded into a van, its cargo needs to be unloaded the same way at its destination, most likely manually. The SLS itself saves time and effort by automating the loading and unloading of a few large or many small items together. However, much additional time and effort can be saved by using customized pallet systems for loading cargo into and out of the SLS. An example of a customized pallet system is demonstrated next.

FIG. 7B shows an exterior floor pallet, or EFP 710, rolling on non-retractable casters. EFP 710 is approaching the SLS, both on ground. Inserted into the SLS is shown a self-loading transfer pallet, or SLTP 712, supported by and rolling on the SLS flow rails. SLTP 712 comprises a horizontal base frame upon which a vertical customization has been added to be described in more detail under FIG. 7F.

In FIG. 7C, EFP 710 has been temporarily attached to the SLS. In FIG. 7D, SLTP 712 has been partly transferred to EPF 710, supported by and rolling on the flow rails of both SLTP 712 and EFP 710. In FIG. 7E, SLTP 712 is wholly resting on EFP 710 and temporarily attached thereto.

FIG. 7F shows EFP 710 on SLTP 712 that is detached and removed from the SLS. SLTP 712 is vertically customized for the transport of building materials. It is inserted into the SLS, thereby converting it to a self-loading version of the shopping dollies seen at major US building materials chains Home Depot and Lowe's. As such, four by eight foot sheets can be dropped in vertically from the top of the SLS.

FIG. 7G details the lower corner of SLTP 712. It has been further customized on the go for the cargo to be carried on any given shopping trip. A supply of tubular supports 714 is stored in the sides of SLTP 712. They are inserted as needed through holed fixtures 716 in the vertical posts of SLTP 712. Supports 714 carry lengths of dimensional lumber or shelving 718, that can hold paint or spackle buckets or similar packaged goods. Here, two different supports 714 carry two different widths of shelving 718. Other supports 714 are long enough to span the full width of SLTP 712 inserted through fixtures 716 in the vertical posts on both of its sides. They are used for loads that mainly consist of dimensional lumber transported lengthwise. The bottom of SLTP 712 may be left uncovered to receive sheets dropped in from the top or may as shown here also be covered by a bottom sheet that supports packaged building materials.

FIGS. 8A through 8D are perspective views of non-palletized wheeled cargo items loaded into bottom floor of SLS without wheel flow rail support.

FIG. 8A shows wheeled cargo items lined up on ground ready to roll into the flat bottom floor of the SLS. Attached to the SLS bottom floor is a hopper door, also acting as a ramp on which wheeled cargo can be rolled onto the SLS floor.

In FIG. 8B, the first wheeled cargo item is shown rolled halfway up the ramp. In FIG. 8C, the first wheeled cargo item is shown as having reached the SLS floor. In FIG. 8D, all wheeled cargo items have reached the SLS floor, and the door is closed.

FIGS. 9A through 9H are perspective views of a pallet on non-retractable casters, with a large cargo item, loaded into bottom floor of SLS without wheel flow rail support.

FIG. 9A shows the pallet ready to roll onto SLS ramp. Here without cargo for a better view. FIG. 9B shows the same pallet with cargo, here having the maximum cargo dimensions that can be loaded this way into this size SLS.

FIG. 9C shows the pallet rolled onto the SLS ramp, here again without cargo for a better view. FIG. 9D shows the same pallet position as described above, but with cargo.

FIG. 9E shows the pallet now partly on the ramp and part way into the SLS, here again without cargo for a better view. FIG. 9F shows the same pallet position as described above, but with cargo.

In FIG. 9G, the pallet has reached its final position on the SLS floor, and the door is closed, here again without cargo for a better view. FIG. 9H shows the same pallet position as described above, but with cargo.

FIGS. 10A through 10F are perspective views of a pallet on casters delivering non-wheeled cargo items into an SLS without itself entering and loading with the SLS.

FIG. 10A shows the pallet with non-retractable casters, but with cargo support flow rails, carrying a series of non-wheeled cargo items. The pallet is on ground approaching the SLS, also on ground.

In FIG. 10B, the pallet has temporarily been coupled to the front of the SLS, both of them with cargo support flow rails at exactly the same height or level above ground. In FIG. 100, half of the non-wheeled cargo items have been rolled from the pallet flow rails onto the SLS flow rails. In FIG. 10D all the cargo items have been moved to the SLS. In FIG. 10E, the pallet has been de-coupled and moved back from the SLS.

FIG. 10F is a detailed view that shows pallet caster 1010, pallet cargo support flow rail 1012, and pallet cargo support guide rail 1014. Guide rail 1014 is one of several alternative devices that can keep the cargo items centered on the pallet and on the SLS that has a similar guide rail. Rail 1014 is here shown as a u-channel in which matching bars on the bottom of the cargo items can slide.

### INDUSTRIAL APPLICABILITY

It is the object of the above-described SLS, with or without an SLP, to bring self-loading capabilities to a range of products so far loaded for transportation manually or by use of external equipment. It is achieved by improving upon the existing technology of industrial shipping containers to arrive at a simpler, safer and more automated operation of self-loading products for more general use. A further object is to simplify the customization of such products with a range of embodiments for alternative sizes, shapes and uses. Finally to do so in capital cost effective ways, both for manufacturers, product customizers and end users of self-loadable products.

Anticipated and targeted uses include industrial, commercial and consumer. At one end of the user spectrum are one-person entrepreneurs who must often load and unload heavy cargo by themselves. At the other end of the user spectrum are vehicle fleets of corporate and franchise chains employing individual drivers on routes that require continuous loading and unloading of heavy cargo units. Consumer uses may range from self-loading carts for varied purposes to van conversion unit inserts and many more in between. A few examples of SLS uses with or without pallets are described below:

For the last mile delivery market of heavy items, or many items delivered together:
1. An SLS can be customized to any vehicle cargo area width, length and height.
2. An SLS can be used with or without a pallet having a similar or shorter length.
3. An SLS can be customized to become a container with side or top openings.
4. Both an SLS and an SLP can be rolled on casters on level horizontal surfaces.
5. A shipper can preload many pallets ready for van operator(s) to load them.
6. At the point of delivery, driver(s) can leave full pallets and pick up empties.
7. An SLS can negotiate levels like curbs, and move up elevators to doorways.
8. An SLS an unload narrow pallets through doorways and locate cargo inside.

The proposed technology can also spin off many other B2B and B2C uses, such as exemplified here:
1. Members of the trades can load and bring with them their shop furniture and unload & reload tools, equipment & material at the work location for the day.
2. Smaller trades, can use family van for work and unload it nights/weekends. Allowing their van to be used for other commercial and/or personal tasks.
3. Caterers can bring to clients all meals and hot/cold equipment in one shot.
4. Institutional meal providers can serve customers without kitchen facilities.
5. Camping fans can skip a costly and seldom used rec vehicle in the driveway. To instead rent a cargo van as needed and self-load a camping unit insert. When unused, insert stores in garage, as guest quarters or a kids' playhouse.
6. Inserts can be customized for team or band travel, flea market vendors, etc.

While the invention herein disclosed fulfills the objects stated above, and while examples of alternative embodiments and ramifications have been shown, it will be appreciated that numerous other modifications and embodiments may be devised by those skilled in the art, and it is intended that the appended claims cover all such modifications and embodiments as may fall within the true spirit and scope of the present invention.

What is claimed is:

1. A three dimensional structure or frame assembly having its main rolling means fixed to a plurality of vertically extendable legs that are slidingly incorporated in the body of said structure and having secondary rolling means attached to each end of a horizontally extendable frame slidingly incorporated in the bottom of said structure, comprising:
a. means of extending and retracting each of said legs vertically, and
b. means of extending and retracting said frame horizontally,
whereby said structure can be vertically maneuvered between a starting level and a receiving level and be horizontally maneuvered on either of said starting or receiving levels.

2. A pallet structure customized for insertion into said self-loading structure of claim 1, said pallet structure having front and rear rolling means capable of retraction to enable said insertion, comprising:
a. means of extending and retracting said front rolling means, and
b. means of extending and retracting said rear rolling means, and
c. means of accepting and carrying a loaded cargo,
whereby said pallet structure of claim 2, with or without cargo, can be manipulated on any horizontal surface and be inserted into said structure of claim 1 to be vertically moved between said starting and receiving levels.

3. The structure of claim 1, wherein said means of claim 1a comprise:
a. an actuator attached to each leg of said structure, incorporating a piston, a motor and a controller, said piston attached to and able to extend and retract said leg based on electronic signals received from said controller, and
b. a programmable master controller able to send electronic signals to said controllers in each of said actuators, to move said pistons to cause the leg extensions and retractions required to elevate and lower said structure, and
c. a rechargeable battery powering each of said motors and controllers in said actuators and optionally said master controller, and
d. electric wiring that connects said battery to said motors and controllers in said actuators and optionally connects to said master controller, and
d. each said leg comprising an upper and a lower telescoping leg part contained in a leg housing,
whereby a sequence of major and minor vertical movements of individual legs can be pre-programmed to automate the vertical movement of said structure between said starting and receiving levels.

4. The structure of claim 2, wherein said means of claim 2a and claim 2b each comprise:
a. casters attached to caster supports that can be rotated by 90 degrees whereby said casters can be toggled between on-ground and off-ground positions, and
b. a handle that can be toggled between, and be secured in, either of the said two positions, said handle attached to a shaft that cooperates with spur and miter gears and additional shafts to toggle said caster supports,
whereby the two rear casters of said structure can be extended and retracted in unison, as can the two front casters independently from the rear casters, said independent extensions and retractions allowing the insertion of the structure of claim 2 into the structure of claim 1.
